(19) United States
(12) Patent Application Publication
(10) Pub. No.: US 2017/0300071 A1
(43) Pub. Date: Oct. 19, 2017

(54) A PRESSURE COMPENSATOR FOR OLEODYNAMIC APPLICATIONS

(71) Applicant: WELL EQUIPMENTS INTERNATIONAL S.R.L., Fiorenzuola d'Arda (PC) (IT)

(72) Inventor: Luigi PEVERI, Fiorenzuola d'Arda (PC) (IT)

(21) Appl. No.: 15/516,562

(22) PCT Filed: Sep. 29, 2015
(86) PCT No.: PCT/IB2015/001722

§ 371 Date: Apr. 3, 2017

(30) Foreign Application Priority Data
Oct. 2, 2014 (IT) MI2014A001724

(51) Int. Cl. G05D 16/10

(52) U.S. Cl. CPC G05D 16/106

(57) ABSTRACT

A pressure compensator, particularly for oleodynamic applications, comprising two cylinders: a compensator cylinder in which is slidingly engaged a first piston comprising a first piston rod, and a reducing cylinder, in which is slidingly engaged a second piston comprising a second piston rod axially connected to the first piston rod; said compensator cylinder being coupled to a main oleodynamic cylinder; said compensator cylinder having a size so designed as to provide the same area ratio as that of the main cylinder, thereby to a set position of said main cylinder piston corresponding a precise position of the first piston of the compensator cylinder; said reducing cylinder comprising at least a low-pressure chamber coupled to a pressure gauge; a displacement of the reducing cylinder piston rod either increases or decreases a pressure in said low-pressure chamber, proportionately to a working pressure in the main cylinder.

### BACKGROUND OF THE INVENTION

The present invention relates to a pressure compensator, for oleodynamic applications.

As is known, for controlling the operation of oleodynamic cylinders, pressure gauges are conventionally used.

The connection of a pressure gauge to an oleodynamic cylinder involves great problems due to the high operating pressures and a need of to protecting the pressure gauge.

A conventional type of pressure gauge must be provided with a safety valve and a pressure compensating membrane.

### SUMMARY OF THE INVENTION

is The aim of the present invention is to provide a pressure compensator, for oleodynamic applications, allowing to connect a pressure gauge to an oleodynamic cylinder with high operating pressures.

Within the scope of the above mentioned aim, a main object of the invention is to provide such a pressure compensator which, as it is arranged between an oleodynamic cylinder and a pressure gauge, allows to display on said pressure gauge precise or accurate pressure values.

Another object of the present invention is to provide such a pressure compensator which, owing to its specifically designed structural features, is very reliable and safe in operation.

According to one aspect of the present invention, the above mentioned aim and objects, as well as yet other objects which will become more apparent hereinafter, are achieved by a pressure compensator, particularly for oleodynamic applications, characterized in that said pressure compensator comprises two cylinders: a compensator cylinder in which is slidingly engaged a first piston comprising a first piston rod, and a reducing cylinder in which is slidingly engaged a second piston comprising a second piston rod axially connected to the first piston rod; said compensator cylinder being coupled to a main oleodynamic cylinder; said compensator cylinder having a size so designed as to provide the same area ratio as the main cylinder, thereby to a set position of said main cylinder piston corresponding a precise position of the first piston of the compensator cylinder; said reducing cylinder comprising at least a low-pressure chamber coupled to a pressure gauge; a displacement of the reducing cylinder piston rod either increases or decreases a pressure in said low-pressure chamber, proportionately to a working pressure in the main cylinder.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative but not limitative example, in the accompanying drawings, is where:

FIG. 1 is a cross-sectional view of the pressure compensator according to the present invention; and

FIG. 2 shows an application example of the subject pressure compensator to an oleodynamic cylinder.

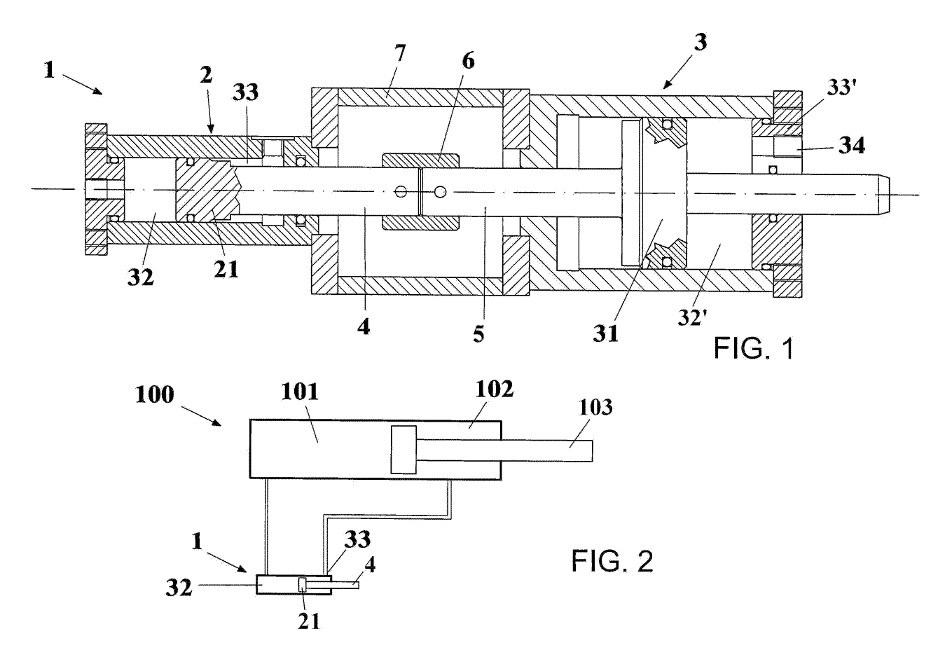

### DESCRIPTION OF THE PREFERRED EMBODIMENTS

With reference to the number references of the above mentioned figures, the pressure compensator, particularly for oleodynamic applications, according to the present invention, which has been generally indicated by the reference number 1, comprises two cylinders: a compensator cylinder 2 in which is slidingly engaged a first piston 21, comprising a first piston rod 4, and a reducing cylinder 3, in which is slidingly engaged a second piston 31, comprising a second piston rod 5, axially connected to the first piston rod 4 through a coupling joint 6 arranged in a spider assembly 7.

The compensator cylinder 2 comprises a first chamber 32 and a second chamber 33 coupled to the first chamber 101 and the second chamber 102 of an oleodynamic main cylinder 100, respectively.

The size of the compensator cylinder 2 is so designed as to provide the same area ratio as the main cylinder 100, on the bottom and rod side, thereby, to a set position of the piston 103 of the main cylinder 100 corresponds a precise position of the first piston 21 of the compensator cylinder 2.

The reducing cylinder 3 comprises a low-pressure chamber 32 closed by a cover 33, having connecting means 34 for a pressure gauge, not shown in the figures.

Since the first piston rod 4 of the piston 21 of the compensator cylinder 2 is coupled to the second piston rod 5 of the second piston 31 of the reducing cylinder 3, the displacement of the second piston rod 5 in the reducing cylinder 3 either increases or decreases the pressure in the low-pressure chamber 32 in a proportional manner to the operating pressures in the main cylinder 100.

The size of the reducing cylinder 3, on the pressure gauge side, and of the compensator cylinder 2, on the annular section side, are so designed as to provide a ratio identical to that between the maximum pressure and a full-scale pressure gauge pressure.

Thus, for example, at a maximum pressure supplying said main cylinder 100, said pressure gauge displays a maximum pressure value, to a minimum supply pressure of said main cylinder 100 corresponding a minimum pressure value of said pressure gauge measuring scale, and so on proportionately for all the intermediate positions.

It has been found that the invention fully achieves the intended aim and objects.

In fact, the invention has provided a pressure compensator which, coupled to an oleodynamic cylinder, allows to provide a reduced pressure connection for a pressure gauge, while assuring that the reduced pressure value is accurately proportional to the operating pressure values of the oleodynamic cylinder at any position of said oleodynamic cylinder pistons.

In practicing the invention, the materials used, as well as the contingent size and shapes may be any, according to requirements.

1-5. (canceled)

6. A hydraulic circuit comprising: a pressure compensator, a high pressure main cylinder, a pressure gauge and said pressure compensator (1) connecting said high pressure main cylinder (100) and said pressure gauge, said main cylinder (100) having a first chamber (101) and a second chamber (102) in which a piston (103) of said main cylinder (100) slides, said pressure compensator comprises two cylinders (2, 3): a compensating cylinder (2) in which slides a first piston (21) comprising a first piston rod (4), and a reducing cylinder (3), in which slides a second piston (31) comprising a second piston rod (5); the compensating cylinder (2) being coupled to said main cylinder (100); said reducing cylinder (3) comprising at least a low pressure chamber (32′) connected to said pressure gauge; a displacement of the piston rod of the reducing cylinder (3) either increasing or decreasing the pressure in said low pressure chamber, proportionately to the working pressures in the main cylinder (100), characterized in that the first piston rod (4) of the first piston (21) of the compensating cylinder (2) is axially connected to the second piston rod (5) of the second piston (31) of the reducing cylinder (3) through a connecting joint (6) arranged in a spider assembly (7), that the compensating cylinder (2) comprises a first chamber (32) and a second chamber (33), respectively coupled to said first chamber (101) and said second chamber (102) of said main cylinder (100), and that a size of said compensating cylinder (2) is designed as to provide a same ratio of the working surfaces of the main cylinder (100), at the bottom and piston rod sides, thereby, to a given position of the piston (103) of the main cylinder (100) corresponds a precise position of the first piston (21) of the compensating cylinder (2)

7. A hydraulic circuit, according to claim 6, characterized in that said low pressure chamber (32′) of said reducing cylinder (3) is closed by a cover (33′) having connecting means (34) for said pressure gauge.

8. A hydraulic circuit, according to claim 6, characterized in that a size of said reducing cylinder (3), at said pressure gauge side, and a size of said compensating cylinder (2), at a narrower cross section, are so designed as to provide a ratio identical to that between a maximum pressure and a full-scale pressure of said pressure gauge, thereby, at a maximum pressure of the main cylinder (100) corresponds a maximum value of the scale of the pressure gauge, and to a minimum pressure of the main cylinder (100) corresponds a minimum value of the pressure gauge scale.

9. A hydraulic circuit, according to claim 7, characterized in that a size of said reducing cylinder (3), at said pressure gauge side, and a size of said compensating cylinder (2), at a narrower cross section, are so designed as to provide a ratio identical to that between a maximum pressure and a full-scale pressure of said pressure gauge, thereby, at a maximum pressure of the main cylinder (100) corresponds a maximum value of the scale of the pressure gauge, and to a minimum pressure of the main cylinder (100) corresponds a minimum value of the pressure gauge scale.
